(19) United States
(12) Patent Application Publication
(10) Pub. No.: US 2020/0054027 A1
(43) Pub. Date: Feb. 20, 2020

(54) Dough piece mold for a dough piece, dough processing method using a plurality of dough piece molds and dough processing installation configured to perform the method

(71) Applicant: Werner & Pfleiderer Industrielle Backtechnik GmbH, Tamm (DE)

(72) Inventor: Klaus Stocklossa, Marbach (DE)

(73) Assignee: Werner & Pfleiderer Industrielle Backtechnik GmbH, Tamm (DE)

(21) Appl. No.: 16/543,671

(22) Filed: Aug. 19, 2019

(30) Foreign Application Priority Data
Aug. 20, 2018 (DE) 10 2018 213 963.6

(51) Int. Cl. A21C 9/08; A21C 11/00; A21D 8/06; A21B 3/13; A21B 7/00; A21B 3/18

(52) U.S. Cl. CPC A21C 9/081; A21C 11/00; A21D 8/06; A21B 3/18; A21B 3/135; A21B 7/005; A21B 3/133

(57) ABSTRACT

A dough piece mold is configured to receive at least one dough piece during a fermentation and baking process. The dough piece mold has at least one machine readable identification label with a ceramic-based carrier, containing identification data, which include mold type data and unambiguous individualization data for the respective dough piece mold. A dough processing installation can be used to perform a dough processing method using a plurality of such dough piece molds.

### CROSS-REFERENCE TO RELATED APPLICATIONS

This application claims the priority of German Patent Application, Serial No. DE 10 2018 213 963.6, filed on Aug. 20, 2018, pursuant to 35 U.S.C. 119(a)-(d), the content of which is incorporated herein by reference in its entirety as if fully set forth herein.

### TECHNICAL FIELD

The disclosure relates to a dough piece mold configured to receive at least one dough piece during a fermentation and baking process. The disclosure further relates to a dough processing method using a plurality of dough piece molds and a dough processing installation configured to perform a dough processing method of this type.

### BACKGROUND

Dough processing installations that use dough piece molds configured to receive at least one dough piece during a fermentation and baking process are known through prior public use, for example by the applicant.

### SUMMARY

It is an object of the present disclosure to refine a dough piece mold for use in a dough processing installation of this type to perform a dough processing method including a fermentation process and, optionally, a baking process in such a way that a quality control as well as a high and energy-efficient dough piece throughput are guaranteed at the same time.

This object is achieved by a dough piece mold configured to receive at least one dough piece during a fermentation and baking process, with at least one machine-readable identification label, containing identification data, which include mold type data and unambiguous individualization data for the respective dough piece mold, the identification label having a ceramic-based carrier.

It was found that an identification label with a ceramic-based carrier allows the dough piece molds to be identified while performing a dough processing method including a fermentation and baking process. This may be used for controlling processing stations of the dough processing installation in which the dough piece molds are being used. The identification label with the ceramic based carrier ensures that neither low temperatures and/or high air humidities during fermentation nor high temperatures during baking will cause an undesirable degradation of the identification label. The carrier of the identification label can be made of a steel ceramic composite material. The identification data of the identification label can be applied by laser engraving or by thermotransfer printing.

A ceramic coating of the carrier ensures a cost-effective production of the identification label of the dough piece mold. The identification data can be applied to said ceramic layer.

A QR code of the identification data ensures a cost-effective automated detection of the identification data by means of a corresponding reading unit or a scanner. The QR code can be configured such that the reading process has a certain error redundancy, allowing a certain degree of deterioration of the identification data, caused for example by wear or dirt, to be tolerated.

Another object of the disclosure is to provide a dough processing method that allows dough piece molds with identification labels, containing identification data including mold type data and individualization data, to be used to particular advantage, and to provide a dough processing installation performing said dough processing method.

This further object is achieved by a dough processing method using a plurality of dough piece molds configured to receive at least one dough piece, each of the dough piece molds having at least one machine-readable identification label, containing identification data, which include mold type data and unambiguous individualization data for the respective dough piece mold, the method comprising the following automated steps: preparing dough pieces to be fermented and baked; preparing the dough piece molds to be filled; filling the dough piece molds with in each case at least one prepared dough piece; fermenting the dough pieces in the dough piece molds; baking the dough pieces in the dough piece molds; removing the baked dough pieces from the dough piece molds; transferring the dough piece molds to a refilling preparation of the dough piece molds, wherein starting from and including the step of preparing the dough piece molds to be filled up to the refilling preparation of the dough piece molds, the following identifications are each carried out once: mold type identification of the dough piece mold; individual identification of the dough piece mold. This method can be performed using a dough piece mold as discussed above.

When performing the dough processing method, a mold type identification allows processing stations, which perform these individual method steps, to be actuated according to type. This may be used, for example, to perform a preparation depending on the mold type and/or a filling depending on the mold type and/or a fermentation depending on the mold type and/or a baking depending on the mold type and/or a removal depending on the mold type and/or a transfer depending on the mold type. In all of these cases, it is guaranteed that the processing step is performed that is adapted to that particular mold type, irrespective of whether dough piece molds are for example removed or exchanged manually between the processing steps.

Furthermore, when performing the dough processing method, an individual identification of the dough piece molds allows particular data to be assigned to a particular dough piece mold, for example the number of processing cycles performed with this dough piece mold and/or particular conditions of the respective dough piece mold such as detected damages and/or a detected special operating condition such as residual amounts of dough undesirably adhering to the mold. When performing the dough processing method, this can be used for an individual treatment of particular dough piece molds, for example a discarding thereof after a particular number of processing cycles and/or a discarding when a damage has been detected and/or a discarding when a special operating condition has been detected.

When performing maintenance operations after reaching a particular number of processing cycles, the dough piece molds can for example be freshly painted.

The advantages of a mold type identification for the various processing variants including a mold type identification after preparing and prior to filling the dough piece molds and/or a mold type identification after fermenting and prior to baking of the dough pieces and/or a mold type identification after baking and prior to removing the dough pieces and/or a mold type identification after removing the dough pieces and prior to transferring the dough piece molds correspond to those that have already been described above, allowing one to respond, during filling, to a number of dough piece receptacles of the respective mold type and/or a dough piece weight depending on the mold type. The same applies to the baking process where a baking program can be set depending on the mold type. The same applies when removing dough pieces depending on the mold type and transferring the dough piece molds depending on the mold type.

The advantages of an individual identification for the various processing variants including an individual identification after filling the dough piece molds and prior to fermenting the dough pieces and/or an individual identification after fermenting and prior to baking the dough pieces and/or an individual identification after removing the dough pieces and prior to transferring the dough piece molds and/or an individual identification after discarding the dough piece molds after removing the dough pieces and/or an individual identification prior to feeding the dough piece molds to a mold storage from which dough piece molds to be filled are removed and in which dough piece molds are stored after removing baked dough pieces also correspond to those that have already been explained above. An individual identification prior to fermenting for example permits an individual assignment of a dough piece mold if a special operating condition has occurred during filling. The same applies in the case of an individual identification after discarding when a special operating condition of the individual dough piece mold has been determined and assigned to said dough piece mold. The same applies in the case of an individual identification prior to conveying the dough piece mold to a mold storage, allowing a corresponding data set, containing for example the number of cycles performed with this dough piece mold, to be assigned to the dough piece mold in the mold storage. Maintenance intervals can also be stored in a data set of this type. A data set of this type may for example also contain maintenance intervals.

An imaging monitoring of the dough piece mold including an imaging monitoring of the dough piece molds immediately after filling the dough piece molds and prior to fermenting the dough pieces and/or an imaging monitoring of the dough piece molds immediately prior to fermenting the dough pieces and/or an imaging monitoring of the dough piece molds immediately after removing the dough pieces allows a special operating condition of the dough piece mold and of the dough pieces provided therein to be detected. An imaging monitoring after filling allows a special operating condition to be detected such as the undesirable filling of a dough piece receptacle with two dough pieces or an incorrect positioning of a dough piece, which is then not placed correctly in the dough piece receptacle. An imaging monitoring directly prior to fermentation allows the influence of a conveying path between filling and a fermentation device to be determined. An imaging monitoring after removal of the dough pieces from the dough piece mold allows one to determine whether there is any undesirable dough left in the dough piece mold. Instead of an imaging monitoring, it is also conceivable to perform a volume determination based on optical measuring values using a sensor. A volume determination of this type can be performed such that a standard volume is compared with a minimum tolerance value on the one hand and a maximum tolerance value on the other. An imaging monitoring or volume determination based on optical measuring values may produce one of the following monitoring results:
volume OK, i.e. volume within the tolerance values;
volume too small, dough piece left in the mold;
volume too small, no dough piece left in the mold;
volume too large; and
sufficient amount of dough pieces placed in a combination of a plurality of dedicated dough piece molds.

This last measuring result may be obtained from a multiple measurement performed by imaging monitoring or volume determination based on optical measuring values and a corresponding combination of the measuring results.

The dough processing method may principally also be carried out without a baking step. In this case, dough piece molds can be used, which are used only for fermentation.

The advantages of a dough processing installation configured to perform a dough processing method, the dough processing installation comprising a mold preparation device for preparing dough piece molds to be filled, a filling device for filling the dough piece molds with in each case at least one prepared dough piece, a fermentation device for fermenting the dough pieces in the dough piece molds, with a baking oven for baking the dough pieces in the dough piece molds, a removal device for removing the baked dough pieces from the dough piece molds, a transfer device for transferring the dough piece molds to a refilling preparation of the dough piece molds, at least one mold type reading unit for reading a mold type identification of a dough piece mold, and at least one individual reading unit for reading an individual identification of the dough piece molds, correspond to those that have already been explained above with reference to the dough processing method.

Mold type reading units may be provided between the mold preparation device and the filling device, may be provided between the fermentation device and the baking oven, may be provided between the baking oven and the removal device, and they may also be provided between the removal device and the transfer device. Individual reading units may be provided behind the filling device and in front of the fermentation device, may be provided behind the fermentation device and in front of the baking oven, may be provided behind the removal device and in front of the transfer device, may be provided behind a deflector downstream of the removal device, and may also be provided in front of a feed unit into a mold storage.

The advantages of a dough processing installation comprising at least one imaging monitoring sensor for monitoring the dough piece molds immediately after being filled with the dough pieces and prior to fermenting the dough pieces correspond to those that have been explained above with reference to the dough processing method according to which an imaging monitoring of the dough piece mold includes an imaging monitoring of the dough piece molds immediately after filling the dough piece molds and prior to fermenting the dough pieces and/or an imaging monitoring of the dough piece molds immediately prior to fermenting the dough pieces and/or an imaging monitoring of the dough piece molds immediately after removing the dough pieces.

A sprinkling device configured to sprinkle the dough piece with flour or seeds may be part of the filling device.

The fermentation device may be subdivided into a primary fermentation device and a secondary fermentation device.

The imaging monitoring after filling may in particular ensure that the dough piece mold is not undesirably underfilled, in other words it does not contain enough dough pieces.

An imaging monitoring sensor or a sensor for volume determination based on optical measuring values may also be provided directly in front of the fermentation device, and may also be provided directly behind the removal device.

A 3D vision sensor or a sensor for volume determination based on optical measuring values is a suitable imaging monitoring sensor.

A 2D scanner or any other reading unit for an identification code can be used as a reading unit in particular for reading the mold type identification and/or for reading the individual identification.

A control system of the dough processing installation can be configured as a head control system. Each processing station is then able to communicate with a dedicated control unit. In addition thereto, the control units of the various processing stations of the dough processing installation are able to communicate with each other.

The dough processing installation allows predetermined processing cycles, so-called processing jobs, to be performed in particular sequentially. One processing job can then be performed using precisely one mold type. When performing the dough processing method, a change between different processing jobs of this type can take place in an automated manner.

A plurality of dough piece molds for receiving at least one dough piece during a fermentation and baking process, each of the dough piece molds having at least one machine-readable identification label, containing identification data, which include mold type data and unambiguous individualization data for the respective mold, allow an efficient operation of the dough processing installation with a high dough piece throughput. It is possible to use several mold sets with different mold types in the dough processing installation at the same time. It is then not necessary for the dough processing installation to be operated in an unmixed manner, in other words only with dough piece molds of the same mold type. It is also conceivable to operate the dough processing installation with different mold types at the same time. A chaotic operation is in particular also possible.

An exemplary embodiment of the invention will hereinafter be explained in more detail, taken in conjunction with the drawings.

### BRIEF DESCRIPTION OF THE DRAWINGS

FIG. 1 shows a perspective view, seen obliquely from above, of a dough piece mold configured to receive a dough piece during a fermentation and baking process in a dough processing installation;

FIG. 2 shows an enlarged sectional view, seen from the side from view direction II in FIG. 1, the Figure showing an identification label of the dough piece mold;

FIGS. 3 to 5 show views, similar to FIG. 2, of further dough piece molds of other mold types, also configured to receive dough pieces during a fermentation and baking process performed in the dough processing installation, the Figures also showing their identification labels;

FIG. 6 shows a plan view of an identification label that may be used in the mold types of the dough piece molds as shown in FIGS. 2 to 5; and

FIG. 7 shows a workflow diagram of a dough processing method performed by means of the dough processing installation using a plurality of dough piece molds of various mold types, the Figure showing a circulation path of the dough piece mold throughout the entire dough processing method.

### DETAILED DESCRIPTION

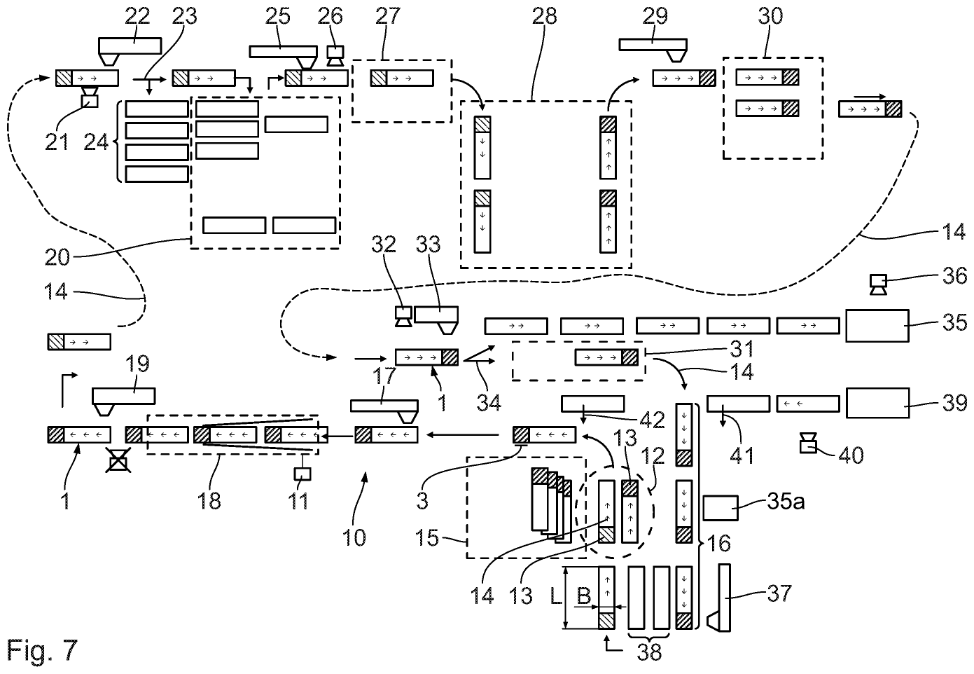

A dough piece mold 1 is configured to receive at least one dough piece during a fermentation and baking process of a dough processing method, which is shown diagrammatically in FIG. 7, the diagram showing a dough piece mold circulation path. The dough piece mold 1 is configured to receive a total of ten dough pieces not shown. Depending on the type of the dough pieces to be processed by means of the method, different types of dough piece molds are provided in the dough processing installation, the different types of dough piece molds also being referred to as mold types.

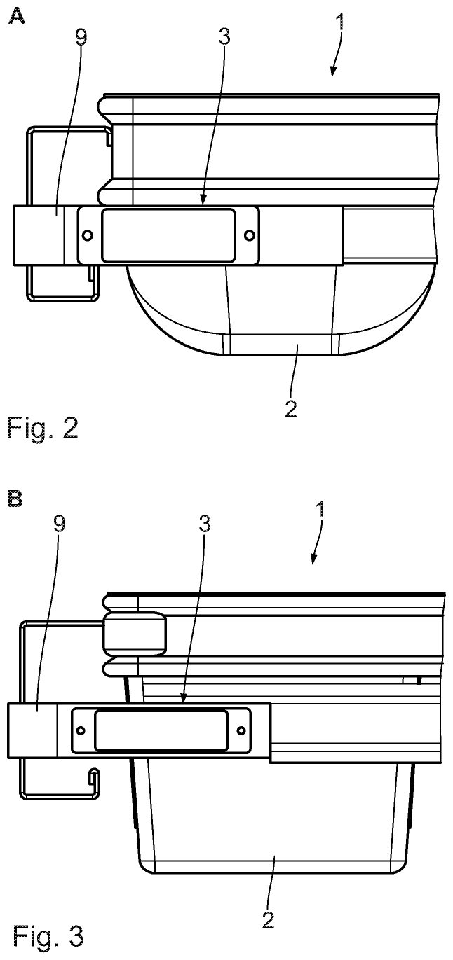

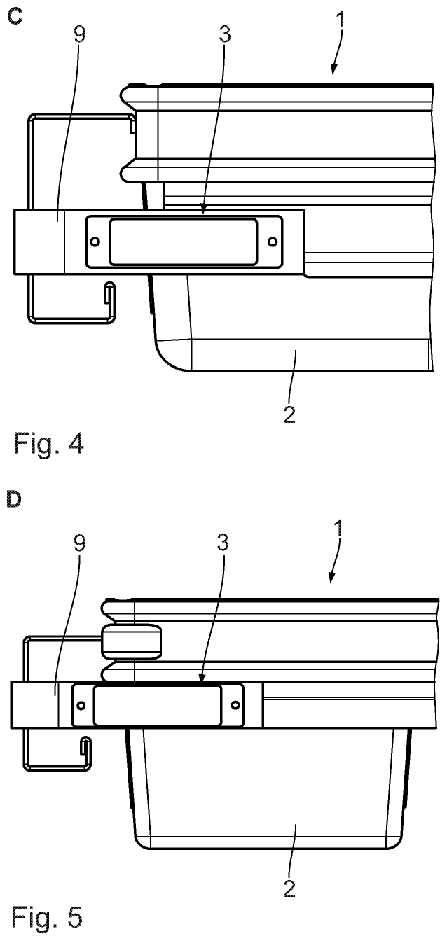

The sectional side views of FIGS. 2 to 5 show examples of such mold types. The mold types differ in the shape of dough piece receptacles 2 and in their width B (cf. FIG. 7 showing a simplified plan view of each of the dough piece molds 1 without differences in their respective sizes; the width B, for example, is indicated at the bottom of FIG. 7). A length L of the different mold types can be equal.

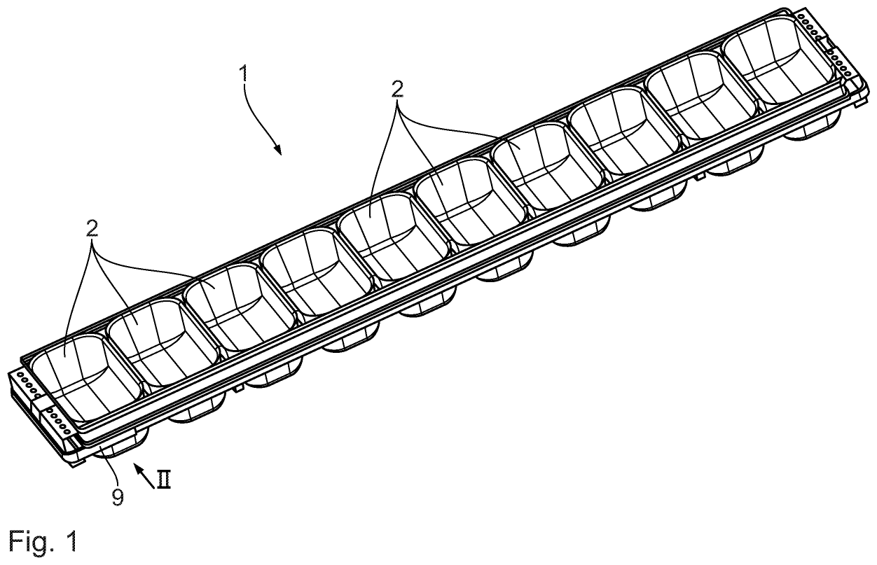

The number of the dough piece receptacles 2 of the respective dough piece mold 1 may be between one and twenty. The dough piece receptacles 2 may be arranged in one row as shown in FIG. 1 for the dough piece mold 1 or also in multiple rows along the length L of the respective dough piece mold 1. The different mold types are referred to as A, B, C and D in FIGS. 2 to 5.

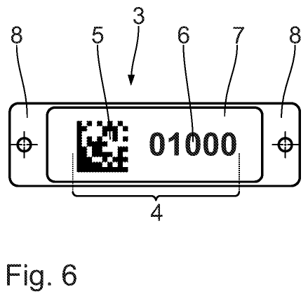

Each of the dough piece molds 1 has at least one machine-readable identification label 3, an example of which being shown diagrammatically in FIGS. 1 to 5 and in more detail in FIG. 6. The identification label 3 carries identification data 4. These identification data include mold type data 5 and unambiguous individualization data 6 for the respective dough piece mold 1. In the exemplary embodiment of the identification labels 3 as shown in FIG. 6, the mold type data 5 are configured as a two-dimensional QR code while the individualization data 6 are configured as a five-digit alphanumerical number. Correspondingly, the identification data 4 can be read using a QR scanner and/or an imaging sensor. The identification label 3 has a ceramic-based carrier 7. The carrier 7 can be made of a steel-ceramic composite material. The identification data are applied to a ceramic coating of the carrier 7. The identification data can be applied by means of laser engraving or thermotransfer printing.

The identification label 3 further has opposing retaining sections 8 allowing the identification label 3 to be secured to a mold carrier 9 of the respective dough piece mold 1. This can be done by screwing, riveting and/or adhesive bonding. The identification label 3 can be secured to the mold carrier 9 by means of a positive connection. The identification label may for example have flexible wings made of a ductile material such as sheet metal, which are bent around corresponding retaining members of the mold carrier.

When performing the dough processing method in a dough processing installation 10 the dough piece mold circulation path of which is shown in FIG. 7, the dough pieces to be fermented and baked are, in a first step, prepared in a dough preparation device 11 as shown diagrammatically in FIG. 7. The dough preparation device 11 may include a blender, a kneader, a dough divider, a portioner, a rounder and a balance, which is not shown in more detail in FIG. 7.

At the same time, the dough piece molds 1 to be filled are prepared in a mold preparation device 12.

In the plan view of FIG. 7, an identification section 13 of the respective dough piece mold 1 is in each case highlighted by a separate rectangle. This identification section 13 can be arranged in a leading and/or a trailing manner in a mold conveying direction 14, which is shown in FIG. 7 by directional arrows in the respective dough piece mold 1 or also between the dough piece molds 1.

The dough piece molds 1 are conveyed along the mold conveying direction 14 in an automated manner by means of motorized conveying units.

The mold preparation device 12 is able to directly refeed dough piece molds 1 recirculated from a completed fermentation and baking process or it decides to temporarily store such recirculated dough piece molds in a mold storage 15. In the mold storage 15, the mold types A to D can be stored according to type in separate storage sections. In order to prepare the dough piece mold 1 to be filled, the mold preparation device 12 is then able to take a mold type, which is selected via a head control system of the dough processing installation 10, either directly from the recirculated molds or from the mold storage 15.

A corresponding recirculation section is shown at 16 in FIG. 7. The recirculation section is part of a transfer device for recirculating the dough piece molds 1 in order to be prepared for filling again.

A mold type identification prior to filling the dough piece mold 1 with the prepared dough pieces is part of the preparation of the dough piece mold 1 to be filled. This first mold type identification is carried out using a first mold type reading unit 17, which is configured as a scanner that reads the mold type data 5 of the respective dough piece mold 1, which are then transmitted to the control system of the dough processing installation 10.

The identified dough piece mold 1 is then filled, in a dough line 18 of the dough processing installation 10, with the dough pieces prepared in the dough preparation device 11. In order to do so, the dough line 18 uses mold type information transmitted by the first mold type reading unit 17. The dough line 18 is therefore a filling device.

Having moved along the dough line 18, the filled dough piece molds 1 pass a first imaging monitoring sensor 19 to monitor the filling quality of the respective dough piece mold 1. In this process, the dough piece mold 1 is monitored to ensure that it is filled completely in accordance with a control setting for the dough line 18. The dough piece mold 1 is also monitored to ensure that none of the dough piece recesses 2 undesirably contains two or more dough pieces. Furthermore, the dough piece mold 1 is monitored to ensure that the filling level of the dough piece in the dough piece receptacle 2 does not undesirably exceed a particular level. Finally, the dough piece mold 1 is monitored to ensure that the correct dough piece size is provided in the filled dough piece receptacle 2. Those dough piece molds 1 that do not meet the quality control requirements of the first imaging monitoring sensor 19 can be discarded immediately or refilled by hand.

Instead of the first imaging monitoring sensor 19 and/or instead of the other monitoring sensors described below, it is conceivable to use sensors configured such that a volume determination is based on optical measuring values. The functionality of such a volume determination sensor corresponds to that of an imaging monitoring sensor.

The filled dough piece molds then move along a conveying path up to a fermentation device 20 of the dough processing installation 10. In the conveying path directly in front of the fermentation device 20, the dough piece molds 1 pass a first individual reading unit 21 for reading the individualization data 6, in other words for reading an individual identification of the dough piece mold 1. The first individual reading unit 21 communicates with the control unit of the dough piece installation 10 for documenting, among other things, a cycle number of the individual dough piece mold 1. Furthermore, the reading process carried out by the first individual reading unit 21 allows information on this individual dough piece mold 1 such as necessary repairs or any other error of this individual dough piece mold 1, to be combined in the dough processing installation 10.

A second imaging monitoring sensor 22 of the dough processing installation 10 is arranged adjacent to the position of the first individual reading unit 21, the tasks of said second imaging monitoring sensor 22 being comparable to those of the first imaging monitoring sensor. The second imaging monitoring sensor 22 allows one to monitor whether changes in terms of the dough piece mold 1 or its filling with dough pieces have occurred along the conveying path between the dough line 18 and the fermentation device 20.

Having passed the first individual reading unit 21 and the second imaging monitoring sensor 22, those dough piece molds 1, which—based on the reading or monitoring result—are not intended for subsequent fermentation or baking, are discarded by means of a deflector 23. The dough piece molds 1 discarded by means of the deflector 23 are identified using the individualization data detected by means of the first individual reading unit 21. Examples of dough piece molds 1 discarded in this manner are shown at 24 in FIG. 7. These discarded dough piece molds 24 can then be sent to maintenance or repair, for example.

The dough piece molds 1 that are not discarded by means of the deflector 23 now undergo a fermentation step in the fermentation device 20. After said fermentation step, the dough piece molds 1 pass a second mold type reading unit 25 and, adjacent thereto, a second individual reading unit 26. The functions of these two reading devices 25, 26 correspond to those that have been explained above with reference to the reading devices 17 and 21.

The dough piece molds 1 then pass through a covering unit 27. Another imaging monitoring sensor not shown in FIG. 7 and configured in the manner of the sensors 19, 22 allows the correct covering of the respective dough piece mold 1 to be monitored, and if necessary, an unsuccessful covering process to be corrected.

Each of the dough piece molds 1 passing through said covering unit 27 and intended to be provided with a mold cover as determined by the control unit of the dough processing installation 10 is then provided with a mold cover such that the dough pieces received in the dough piece receptacles 2 are closed on all sides. In other words, it is conceivable to provide all dough piece molds 1 with corresponding mold covers or it is conceivable to provide only those dough piece molds 1 with a mold cover which are intended to be provided with a cover of this type in accordance with a product planning strategy stored in the control unit.

For this purpose, the covering unit 27 uses the mold type information transmitted by the second mold type reading unit 25.

If the dough piece mold 1 has not been covered correctly in the covering unit 27, this result is linked with the individualization data of the associated dough piece mold 1, which are transmitted to the covering unit 27 by the second individual reading unit 26.

The dough piece molds 1, which may then be provided with a cover, then pass through a baking oven 28 of the dough processing installation 10. Said baking oven 28 can be a conveyor baking oven, in particular a tunnel oven. The tunnel oven can be an oven with several conveyor baking spaces in particular arranged on top of each other in multiple levels. The baking oven 28 is configured for continuous conveyor baking, in other words not just for batch processing. The baking oven 28 as a heat source can be operated using a gas burner, thermal oil or electricity.

If not explicitly stated otherwise in the following sections, the illustration of the circulating conveyor path of the respective dough piece molds 1 refers to the circulation path of precisely one conveyor baking space of the baking oven 28.

After baking the dough pieces in the baking oven 28, the dough piece molds 1 pass a third mold type reading unit 29 the function of which corresponds to that of the mold type reading unit 17 and 25. The still hot dough piece molds 1, which may still have a temperature of more than 100° C., then pass through a cover removal unit 30. In the cover removal unit 30, the mold covers, if provided, are removed from the dough piece molds 1. For this purpose, the cover removal unit 30 uses the mold type data transmitted by the third mold type reading unit 29. In the cover removal unit 30, the baked dough pieces are also removed from the dough piece receptacles 2 of the respective dough piece mold 1. The cover removal unit 29 is therefore also a removal device for removal from the dough piece molds 1. The baked and removed dough pieces are cooled, arranged in groups, carried away and finally packed.

Having passed through the cover removal unit 30, the respective dough piece mold 1 is conveyed to a cooling device 31 configured as a cooling tunnel.

In front of the cooling device 31, the respective dough piece mold passes a third individual reading unit 32 and a third imaging monitoring sensor 33. The function of the third individual reading unit 32 corresponds to that of the individual reading devices 21 and 26. The third imaging monitoring sensor is used to monitor whether the dough pieces have been removed from the dough piece receptacles 2 of the respective dough piece mold 1 sufficiently without any dough remaining therein.

If it is detected by means of the third imaging monitoring sensor 33 that there is still some dough left in some of the dough piece molds 1, these dough piece molds 1 are discarded by means of another deflector 34 to a cleaning station 35. There, the identification data 4 of each of the discarded dough piece molds 1 are again read by means of a fourth individual reading unit 36.

Dough piece molds 1 not discarded by the deflector 34 pass through the cooling device 31 and subsequently enter the return section 16 such that a closed circulation path is obtained for the dough piece molds 1. In the return section 16, the dough piece molds 1 including the identification labels 3 are cleaned using a cleaning unit 35a. The dough piece molds 1 also pass a fourth mold type reading unit 37 in the return section 16. Between the return section 16 and the mold preparation device 12, the dough processing installation 10 also has stacking device 38 for the dough piece molds 1. The stacking device 38 and the mold storage 15 use the mold type data provided by the fourth mold type reading unit 37.

The circulation path of the dough piece molds 1 further includes a feed unit 39 for new and/or reconditioned dough piece molds 1 for all mold circuits of the various conveyor baking spaces of the baking oven 28. Having been fed using the feed unit 39, the dough piece molds 1 pass a fifth individual reading unit 40. Said fifth individual reading unit 40 cooperates with a deflector, which serves to decide to which mold circuit, in other words to which conveyor baking space the respective dough piece mold belongs. Depending on the reading result of the fifth individual reading unit 40, the re-fed dough piece molds 1 are either conveyed, via a deflector 41, to a mold storage (not shown) of another mold circuit or they are conveyed, via a deflector 42, to the mold storage 15 of the mold circuit shown in FIG. 7. When selecting the storage place for the re-fed dough piece mold 1, the mold storage 15 uses the reading data of the fifth individual reading unit 40.

What is claimed is:

1. A dough piece mold configured to receive at least one dough piece during a fermentation and baking process,
with at least one machine-readable identification label, containing identification data, which include mold type data and unambiguous individualization data for the respective dough piece mold,
the identification label having a ceramic-based carrier.

2. The dough piece mold as claimed in claim 1, wherein the carrier has a ceramic coating.

3. The dough piece mold as claimed in claim 1, wherein the identification data comprise a QR code.

4. A dough processing method using a plurality of dough piece molds configured to receive at least one dough piece, each of the dough piece molds having at least one machine-readable identification label, containing identification data, which include mold type data and unambiguous individualization data for the respective dough piece mold, the method comprising the following automated steps:
preparing dough pieces to be fermented and baked;
preparing the dough piece molds to be filled;
filling the dough piece molds with in each case at least one prepared dough piece;
fermenting the dough pieces in the dough piece molds;
baking the dough pieces in the dough piece molds;
removing the baked dough pieces from the dough piece molds;
transferring the dough piece molds to a refilling preparation of the dough piece molds,
identifying a mold type of the dough piece mold, and
individually identifying the dough piece mold.

5. The dough processing method as claimed in claim 4, wherein at least one of the following steps is carried out:
a mold type identification after preparing and prior to filling the dough piece molds;
a mold type identification after fermenting and prior to baking of the dough pieces;
a mold type identification after baking and prior to removing the dough pieces;
a mold type identification after removing the dough pieces and prior to transferring the dough piece molds.

6. The dough processing method as claimed in claim 4, wherein at least one of the following steps is carried out:
an individual identification after filling the dough piece molds and prior to fermenting the dough pieces;
an individual identification after fermenting and prior to baking the dough pieces;
an individual identification after removing the dough pieces and prior to transferring the dough piece molds;
an individual identification after discarding the dough piece molds after removing the dough pieces;
an individual identification prior to feeding the dough piece molds to a mold storage from which dough piece molds to be filled are removed and in which dough piece molds are stored after removing baked dough pieces.

7. The dough processing method as claimed in claim 4, further comprising at least one of the following steps:
an imaging monitoring of the dough piece molds immediately after filling the dough piece molds and prior to fermenting the dough pieces;
an imaging monitoring of the dough piece molds immediately prior to fermenting the dough pieces;
an imaging monitoring of the dough piece molds immediately after removing the dough pieces.

8. A dough processing installation configured to perform a method as claimed in claim 4,
with a mold preparation device for preparing dough piece molds to be filled;
with a filling device for filling the dough piece molds with in each case at least one prepared dough piece;
with a fermentation device for fermenting the dough pieces in the dough piece molds;
with a baking oven for baking the dough pieces in the dough piece molds;
with a removal device for removing the baked dough pieces from the dough piece molds;
with a transfer device for transferring the dough piece molds to a refilling preparation of the dough piece molds;
with at least one mold type reading unit for reading a mold type identification of a dough piece mold;
with at least one individual reading unit for reading an individual identification of the dough piece molds.

9. The dough processing installation as claimed in claim 8, comprising at least one imaging monitoring sensor for monitoring the dough piece molds immediately after being filled with the dough pieces and prior to fermenting the dough pieces.

10. The dough processing installation as claimed in claim 8, comprising a plurality of dough piece molds for receiving at least one dough piece during a fermentation and baking process, each of the dough piece molds having at least one machine-readable identification label, containing identification data, which include mold type data and unambiguous individualization data for the respective mold.
